(19) United States
(12) Patent Application Publication
(10) Pub. No.: US 2002/0025803 A1
(43) Pub. Date: Feb. 28, 2002

(54) Apparatus for controlling a door using a mobile radio communication system

(76) Inventor: Yong Duk Park, Tokyo (JP)

Correspondence Address: PERKINS, SMITH & COHEN LLP, ONE BEACON STREET, 30TH FLOOR, BOSTON, MA, 02108, US

(21) Appl. No.: 09/879,316

(22) Filed: Jun. 12, 2001

(30) Foreign Application Priority Data
Jul. 21, 2000 (KR) 2000-41900

(51) Int. Cl. H04Q 7/20

(52) U.S. Cl. 455/420; 455/41; 455/517

(57) ABSTRACT

An apparatus for controlling a door using a mobile radio communication system is disclosed, in which the door of an apartment, a building, an automobile, a traveller's bag, a parking lot or the like can be automatically unlocked by using a mobile radio communication terminal at a remote place. The apparatus for controlling a door using a mobile radio communication system includes a transmitting device for generating control signals for unlocking the door, the door having an automatic locking device equipped with a receiving device for receiving wireless signals. It further includes a mobile radio communication terminal which can be connected through a wire to the transmitting device, for converting the control signals, the door unlocking signals, generated in the transmitting device into wireless signals for delivery. The wireless signals for unlocking the door are received by the receiving device installed in the door locking device for the door to be unlocked automatically.

### BACKGROUND OF THE INVENTION

1. Field of the Invention:

The present invention relates to an apparatus for controlling a door using a mobile radio communication system, with which the user of the apparatus can automatically unlock and open a door of an apartment, a building, an automobile, a traveller's bag, a parking lot and the like.

More specifically, under the circumstances where the door is provided with a locking device (a door locking device) equipped with a device for receiving wireless signals and where a transmitting device which generates control signals for automatically unlocking the door is additionally provided, the user of the apparatus outside the door or at a remote place from the door connects his mobile radio communication terminal to the transmitting device which he is carrying with him or her and delivers the door-unlocking signals generated in the transmitting device through his or her mobile radio communication terminal, such as a mobile telephone, after having converted the door-unlocking signals into wireless signals.

The receiving device installed in the door-locking device receives the wireless signals discharged from the mobile radio communication terminal and the door is automatically unlocked and opened.

2. Description of the Prior Art:

Generally, using a mobile radio communication terminal, the user makes or receives phone calls while travelling or where ordinary telephone is not available. Recently, mobile radio communication terminals have added to their telephonic functions, introducing such functions as data communications, vocal PO box, Internet and the like.

In spite of their numerous functions, mobile radio communication terminals have not been used for the remote control of a door equipped with an automatic door-locking device.

In the conventional automatic door locking apparatus, if a user inside the door operates a remote control (wireless) or a switch (with wire) to impress signals for unlocking or locking the door, the door-locking device receives these signals and automatically drives a motor to lock or unlock the door. In controlling this conventional automatic door-locking apparatus from outside the door, a key is used to lock or unlock the door.

If the door is locked and there is no one in the house, and if one who has the key, such as a person who is a member of the house, has left the key inside the door or has lost the key, he or she cannot open the door even if he wants to enter the house.

Further, when there is no one inside the door, if a visitor visits the house, the visitor being an important person whom the owner of the house wants to let him or her in, the visitor has to wait for a member of the house having the key to arrive to get in the house or turn away without being able to enter the house.

### SUMMARY OF THE INVENTION

The present invention is intended to overcome the above-described situations, to solve the problems in situations where there is no one inside the door with the door locked and a visitor who must see a member of the family of the house arrived or where a member of the family of the house lost a key to the house, and so on.

Therefore it is an object of the present invention to provide an apparatus for controlling a door with a mobile radio communication system, with which a door of an apartment, a building, an automobile, a traveller's bag, a parking lot or the like can be automatically opened by using a mobile radio communication terminal, such as a mobile telephone, using the apparatus at a remote place.

More specifically, the present invention relates to an apparatus for controlling a door using a mobile radio communication system wherein a locking device (a door locking device) is provided for the door for automatically locking and unlocking a door, the door-locking device being provided with a receiving device for receiving wireless signals; a transmitting device is provided for transmitting control signals for automatically unlocking the door. The user of the apparatus who is outside his house and at a remote place from his house connects the transmitting device to the mobile radio communication terminal, such as a mobile telephone, which he is carrying with him, and then converting the door-unlocking signals generated in the transmitting device into wireless signals, the user delivers the door-unlocking signals (which is converted into wireless signals) to the receiving device provided in the door-locking device through his mobile radio communication terminal, and the door is automatically unlocked and opened.

In achieving the above object, the apparatus for controlling a door using a mobile radio communication system according to the present invention includes:

a transmitting device for generating control signals to lock or unlock a door at a remote place, the door being provided with an automatic door-locking device;

a mobile radio communication terminal which is connected with said transmitting device through wire and delivers control signals generated through said transmitting device, converting the control signals into wireless signals;

a receiving device provided in said door-locking device which receives and analyzes the wireless signals delivered from said mobile radio communication terminal and, if the signals thus analyzed are door-unlocking signals, automatically controls a motor and unlocks the door.

### BRIEF DESCRIPTION OF THE DRAWINGS

The above object and other advantages of the present invention will become more apparent by describing in detail the preferred embodiment of the present invention with reference to the attached drawings in which:

FIG. 1 is a schematic view showing the overall structure of the door control apparatus using a mobile radio communication system according to the present invention.

FIG. 2 is a circuital illustration showing an embodiment of the transmitting device of the door control apparatus according to the present invention; and

FIG. 3 is a circuital illustration showing an embodiment of the receiving device of the door control apparatus according to the present invention.

### DETAILED DESCRIPTION OF THE PREFERRED EMBODIMENT

The preferred embodiment of the present invention will be described in detail based on the technical conceptions of the present invention.

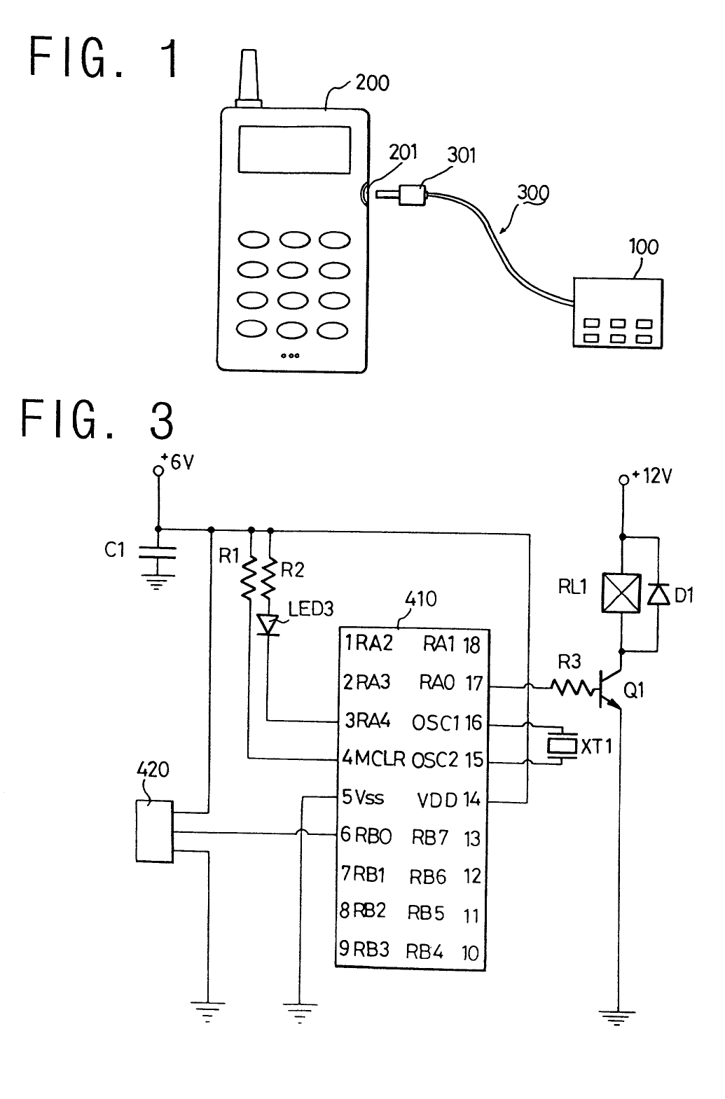

FIG. 1 is a schematic view showing the overall structure of the door control apparatus using a mobile radio communication system according to the present invention.

In FIG. 1, Reference Code 100 is a transmitting device generating control signals for unlocking, at a remote place, the automatic door-locking device provided for the door. Reference Code 200 is a mobile radio communication terminal which is connected to said transmitting device 100 through a wire 300 and delivers the control signals generated in transmitting device 100, converting the control signals into wireless signals. Here, the transmitting device 100 is a separate device which is carried by the user of the apparatus who also carries a mobile radio communication terminal 200.

The door control apparatus of the present invention thus constituted will now be described in further detail as to its functions referring to FIGS. 1 to 3.

For the sake of convenience in describing the present invention, it will be assumed that: a person 1 is the one who has lost the key to the door locking device (or a visitor to the house); and a person 2 is the one who is carrying with him or her a transmitting device 100 and a mobile radio communication terminal 200. It will be further assumed that the person 1 and the person 2 are located outside of the locked door.

First, the person 1 who has returned home but has no key with him or her calls the person 2 by telephone.

Then the person 1 tells the person 2 that he or she has left the key to the door inside house or has lost the key, and asks the person 2 to open the door for him or her.

If the person 2 wants to open the door for the person 1, the person 2 connects the transmitting device 100 to his or her mobile radio communication terminal 200 through the wire 300. Here, one end of the wire is already connected to the transmitting device 100, and therefore, only the other end of the wire 300 has a jack 301 for connection to the mobile radio communication terminal 200.

Then the person 2 connects the transmitting device 100 to his or her mobile radio communication terminal 200 by inserting the jack 301 into the interface jack 201 of the mobile radio communication terminal 200.

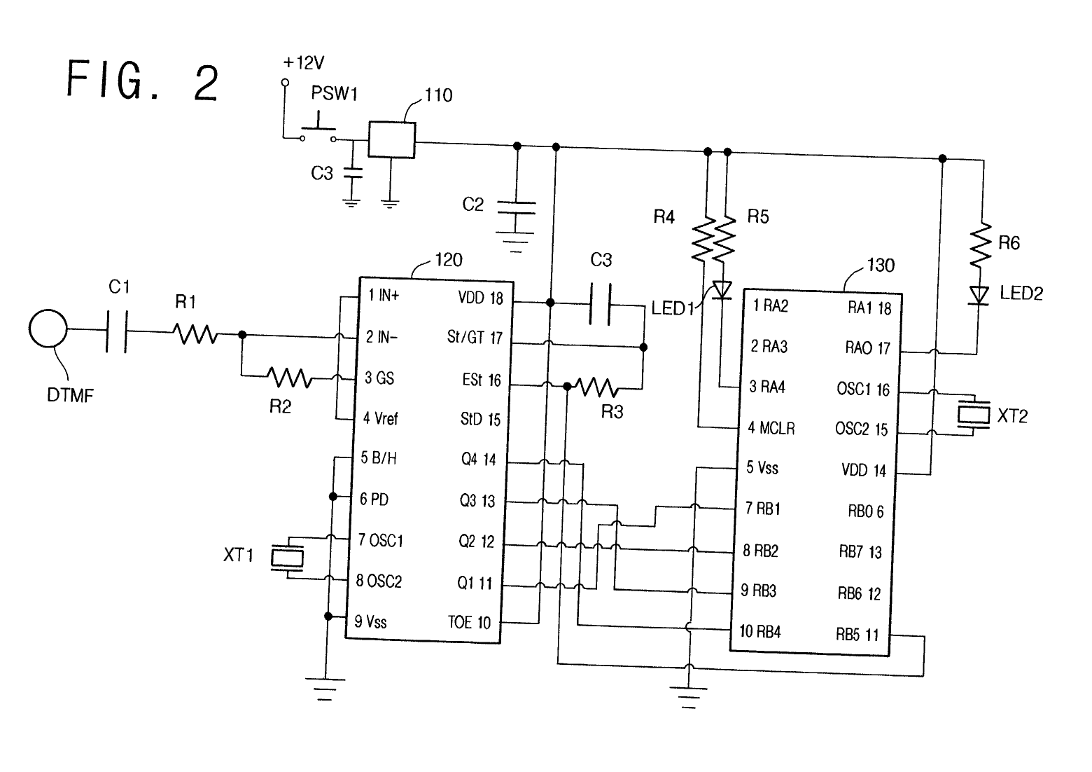

Then the person 2 generates control signals for unlocking the door by means of the transmitting device 100 of FIG. 2, and passes on said control signals for unlocking the door to the mobile radio communication terminal through the wire 300.

As shown in FIG. 2, the transmitting device 100 comprises: a power switch PSW1 for supplying power; a constant voltage regulator 110 for maintaining power source (12 V) at a constant voltage when the power switch PSW1 is turned on; a receiver 120 for detecting DTMF signals responding to the manipulation of buttons or keys by the user; and a control signal generator 130 that generates control signal data in response to the DTMF signals detected by the receiver 120.

The power source supplied is a battery.

In operating the transmitting device 100 thus constituted, the user first turns on the power switch PSW1, then the driving power (12 V) flows into the constant voltage regulator 110, which then steps down the power source voltage (12 V) into a constant voltage of 5V to supply it to the receiver 120 and the control signal generator 130.

When the constant voltage of 5V is supplied as described above, the receiver 120 detects the DTMF signals generated in response to the user's manipulation of the key pad, whereby the numbered keys on the key pad are pressed appropriately to generate the signals, and converts these signals into data to pass them on to the control signal generator 130.

Then the control signal generator 130 recognizes the data outputted from the receiver 120 and generates and outputs the door-unlocking signal in response to said data. The control data for unlocking the door are passed on to the controlling means (not shown in drawings) in the mobile radio communication terminal 200 through the wire 300, the jack 301 and the data interface jack 201.

Then the controlling means recognizes the control data and generates the corresponding wireless signals and radiates them into the air.

In other words, the mobile radio communication terminal 200 converts the door-unlocking control signals, which are passed on by the transmitting device 100, into wireless signals and delivers them into the air.

Then a receiving device 400 (not shown in drawings) as in FIG. 3 which is provided for the door-locking device receives and analyzes the wireless signals.

In other words, as shown in FIG. 3, the receiving device 400 receives the wireless signals delivered from the mobile radio communication terminal 200 at its wireless signal receiving means (not shown in drawings), and generates a relay control signal at the door lock controlling means 410 through the port RAO according to the data obtained from processing said wireless signals.

Of course, also in the case where the user delivers infrared rays through a remote controller to open the locked door, the door lock controlling means 410 receives the infrared rays through an infrared ray receiver 420 to convert the infrared rays into electrical signals, and generates relay control signals through the port RAO according to the converted electrical signals as described above.

A switching device Q1 is turned on according to the relay control signals thus generated, and when the switching device Q1 is turned on, a driving current flows into a relay RL1, thereby automatically unlocking the door lock.

In the above, the present invention was described for automatically unlocking a door having an automatic door-locking device in apartments and buildings. However, the application of the present invention will not be limited thereto but may be extended to automobile doors, traveller's bags, bed room doors, parking lot wire-lock doors, hotel rooms, garages and the like.

According to the present invention as described above, in the case where the user has lost the key or has left the key inside the door, the door can be unlocked using a mobile radio communication terminal, such as a mobile phone.

Further, when a visitor visiting a house during the absence of the owner of the house who wants to let the visitor enter the house, the owner of the house can unlock the door for the visitor by remote control using a mobile radio communication terminal, which is very convenient for the user.

What is claimed is:

1. An apparatus for controlling a door by a mobile radio communication system, comprising:
a transmitting device for generating control signals to unlock at a remote place a door-locking device provided for a door, said door having a locking device;
a mobile radio communication terminal connected to said transmitting device through a wire for converting said control signals generated through said transmitting device into wireless signals for delivery; and
a receiving device installed within a door locking device of said door, for receiving and analyzing said wireless signals delivered by said mobile radio communication terminal and for automatically controlling a motor and unlocking the door if the analyzed signals are door-unlocking signals.

2. The apparatus as claimed in claim 1, wherein said transmitting device comprises:
a power switch PSW1 for power supply;
a constant voltage regulator 110 for maintaining a desired level of constant voltage of the power (12 V) when the power is turned on by the switch PSW1.;
a receiver 120 for detecting DTMF signals in response to the user's manipulation of buttons; and
a control signal generator 130 for generating control signal data in response to the DTMF signals detected by said receiver 120.

3. The apparatus as claimed in claim 1, wherein said receiving device comprises:
a door lock control means 410 for receiving wireless signals delivered by said mobile radio communication terminal to process said wireless signals so as to generate relay control signals through a port RAO according to the data obtained from said processing of wireless signals;
a switching element Q1 for carrying out switching operations according to the relay control signals outputted from said door lock control means 410; and
a relay RL1 for automatically unlocking the door lock by the power which is supplied when said switching element Q1 is turned on. on.
